(19) United States
(12) Patent Application Publication
(10) Pub. No.: US 2018/0160657 A1
(43) Pub. Date: Jun. 14, 2018

(54) Sea lice fish pump

(71) Applicant: Peter B. Lindgren, Pompano Beach, FL (US)

(72) Inventor: Peter B. Lindgren, Pompano Beach, FL (US)

(21) Appl. No.: 15/592,886

(22) Filed: May 11, 2017

Related U.S. Application Data
(60) Provisional application No. 62/432,955, filed on Dec. 12, 2016.

(51) Int. Cl. A01K 61/13; A01K 79/00; F04D 29/44

(52) U.S. Cl. CPC A01K 61/13; F04D 29/445; A01K 79/00

(57) ABSTRACT

An assembly designed to encourage fish to enter a Coanda effect fish pumping system head first to allow delicing through the pump. The assembly includes a funnel shaped tube made of spaced bars and a water distribution system that provides a current that fish will swim toward. Once within the funnel shaped tube, wall spacing allows the current to dissipate where a suction current of the pump further transfers the fish. The current changes within the Coanda effect pump provide delicing of the fish by orientating the fish in a forward direction as the fish pass through the pump.

### PRIORITY CLAIM

In accordance with 37 C.F.R. 1.76, a claim of priority is included in an Application Data Sheet filed concurrently herewith. Accordingly, this present invention claims priority to U.S. Provisional Patent Application No. 62/432,955 entitled “SEA LICE FISH PUMP” filed Dec. 12, 2016. The contents of the above referenced application is incorporated herein by reference.

### FIELD OF THE INVENTION

This invention relates to the fishing industry and, more particularly, to a fish pump apparatus constructed and arranged to remove sea lice from salmon.

### BACKGROUND OF THE INVENTION

Many species of fish are farmed offshore in large net pens. One of the most popular is salmon. However, there is a major problem today with infestation of sea lice on farmed salmon. With the salmon industry growing rapidly, the close proximity and cross contamination makes managing sea lice on salmon challenging.

Sea lice are marine copepods of the family Caligidae, with several each of the species Lepeophtheirus and Caligus. They are a naturally occurring parasite that have existed on wild fish well before salmon farming efforts, although there is speculation that farming efforts have increased the spread of lice to wild fish. Populations of sea lice on fish are no threat to humans, but they leave marks on fish that lower market value and increase likelihood of disease. Currently, environmentalist claim that sea lice cause mortalities on salmon fingerlings returning to the ocean from rivers and, therefore, resulting in fewer fingerling survivors and fewer mature adult spawning river returns.

Treatment for sea lice infestations can take many forms in a farm environment. Several chemical treatments are currently available, the most prevalent being SLICE (Emamectin benzoate EMB). SLICE can be presented to fish through inclusion in feed. Each application technique has obvious drawbacks. Application techniques are difficult to control effective dosage, and neither have a mechanism to prevent the SLICE from entering into the environment.

Other treatments involve bathing salmon in a solution of hydrogen peroxide. It is not harmful to the environment, so it can be pumped back into the ocean. Removing high percentages of lice with hydrogen peroxide is very expensive due to the high capital cost in the form of specialized equipment. Crowding and conventional pumping can cause undue stress on the fish, leading to temporary reduced feeding and growth, degrading marks and or mortalities. Bathing fish in fresh and warm water can also be effective, but at a huge cost of energy and handling. Salmon farmers and government regulators are responding, creating huge cost increases to control the problem.

SILKSTREAM™ is a Coanda effect live fish pump, U.S. Pat. No. 7,462,016, having the capability of removing up to 70% of sea lice when pumping salmon. The fish are then dewatered and the water is filtered to remove and destroy the lice.

In many applications, it is preferred to have fish moved head first for sea lice removal or harvesting. There exist fish pumps that have improved the ability to transfer fish head first by encouraging them to enter tail first and then reverse their direction in the water stream. What is lacking in the art is an assembly capable of removing sea lice from salmon during a pump transfer.

### SUMMARY OF THE INVENTION

Disclosed is an assembly designed to encourage fish to enter a fish pumping system head first to allow delicing through a pump employing a Coanda effect. The assembly includes a funnel shaped element constructed of spaced bars and a water distribution system that provides a current that fish will swim toward. Once within the funnel shaped tube, wall spacing allows the current to dissipate where a suction current of the pump further transfers the fish. The current changes within the Coanda effect pump to provide delicing of the fish by orientating the fish in a forward direction as the fish pass through the pump.

An objective of the invention is to teach an efficient and effective method of removing sea lice from salmon that does not use chemicals.

Another objective of the invention is to provide a method of removing sea lice from salmon by proper orientation of a fish through a Coanda effect pump.

Still another objective of the invention is provide a cone shaped apparatus to be placed before a fish pump that is capable of providing a current flow that allows a fish to swim toward a current, and which is sized to prevent the fish from turning around once the current flows in an opposite direction.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### DESCRIPTION OF THE DRAWINGS

FIG. 1 is a pictorial view of a counter-flow funnel;

FIG. 2 is a pictorial view of a counter-flow funnel with an input water manifold; and

FIG. 3 is a perspective view of FIG. 2.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

Fish can be transferred or “pumped” live for grading, transporting, inoculation, or any other reason by the use of specialty pumps. These pumps are typically located on boats, barges and docks, and large hoses are used to enter into the cage used to house the fish. The hoses are usually constructed with a small, formed metal cone at the suction end. Nets are moved and lifted to crowd the fish to the inlet of the hoses.

Fish are preferably transferred using specialty pumps that are capable of moving fluid without an inline impeller. Known pumps include: SILKSTREAM™, TRANSVAC®, and Magic Valley, to name a few. SILKSTREAM™ is a Coanda effect pump as disclosed in U.S. Pat. No. 7,462,016 which discloses a technology for pumping larger fish in a manner that is stress free, compared to previous technology, to meet the demands for larger high quality fish. Studies performed with Silkstream pumps have demonstrated their ability to remove sea lice, notably with the Loch Duart company in Scotland. Other studies report having removed 40-70% of lice when pumping with Silkstream while grading fish, or for other lice treatment.

It has also been shown that when fish entered the pump head first, as opposed to tail first, delousing was improved. When fish are pumped, a net within the housing is lifted and moved to crowd the fish, wherein the fish generally get sucked into the pump randomly. Silkstream pumps operate using the Coanda effect that a liquid stream will follow a curved surface. The Silkstream pump enters water to a tube concentrically at a high velocity on a curved cone surface to create inlet suction. For example, the 10 inch pump commonly used on salmon fish requires approximately 2,000 GPM for a 2 meter lift. The inlet water with fish will be approximately 1,000 GPM. The water stream will triple velocity in less than 4 inches. Therefore, there is an area where the fish and the water are not at the same speed. Sea lice develop through several life stages. This is a unique pump using Coanda effect to create intake suction and pump live fish through the pump with no moving parts. As the fish move head first from the low pressure intake to the high pressure pump area, sea lice which are attached by being hooked to scales are effectively removed by the faster current.

During adult and sub adult stages, the sea lice can be mobile and attach to salmon by hooking on scales or with a filament. The velocity difference between the water and the fish remove sea lice. Fish that enter a current head first receive higher velocity water from tail to head, which easily detaches hooked on sea lice and the filament. Fish that enter a current tail first receive a velocity gradient from tail to head and the hooked on lice stay hooked. Test results for Salmon entering water streams of 0.3 to 1 PSI from head to tail produces almost no removal until over 1 PSI while tail to head 0.3 psi is effective to detach all lice tested.

It is recognized that captive salmon prefer swimming into water currents when possible because they have very limited ability to travel backward. This is especially true when the fish are being crowded during harvest pumping. The suction of the pump traditionally creates a current that encourages salmon to swim away from the pump suction cone inlet as they draw closer, increasing the probability that the fish is drawn into the pump tail first.

The solution is to provide a water current near the inlet of the pump, effective to encourage the fish to swim head first and then confine the fish sufficient that they cannot turn around when they enter the suction area. For this reason the system must also provide suction water entrance for the pumping system.

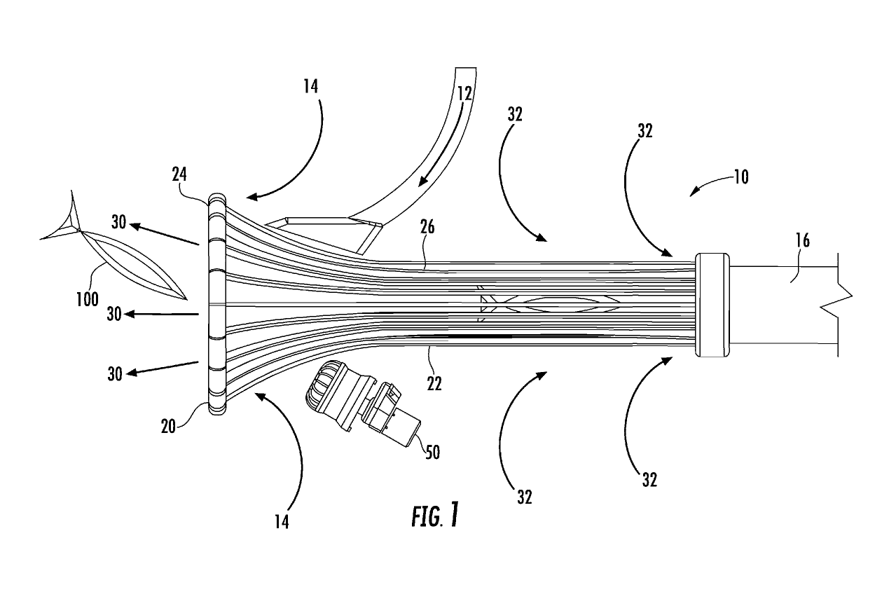

Referring to FIG. 1, the design uses a water distribution manifold 10 comprising a water pump 12 with sufficient volume to create a current 14 opposite a pump suction member 16. The current is pushed through a cone shaped structure 20 placed in a position prior to the pump suction member 16. In a preferred embodiment, a current producing about 0.3 to 1 foot/second provided with a 3 inch centrifugal pump with outputs of 200 to 500 GPM is deemed sufficient for most fish transfer applications. The fish 100 naturally swim toward the current 14 in a head first position. The structure 20 is preferably constructed of clear or translucent plastic bars 22 which lessen the stress on the fish and more easily encourages the fish to enter the structure 20 along an outer edge defining a fish capture funnel 24. The translucent spaced apart bars 22 are less conspicuous to the entering fish, and are preferably made of clear plastic using acrylic, polycarbonate, or the like material. For increased durability, small metal bars can be used.

Alternatively, or in addition thereto, water flow could also be provided by an underwater source including a propeller 50. In this embodiment, the cone shaped structure 20 is coupled to the end of a conventional pump suction member 16, which may be a flexible tube. The structure 20 has the bars 22 in a spaced apart configuration so as to allow the current to flow around the bars 22 and outward from the fish capture funnel 24 as depicted by arrows 30. Dependant on the length of the structure 20, a reinforcement ring 26 may be used to maintain a spaced separation of the bars 22. Fish 100, with their natural inclination to swim toward current, enter the capture funnel 24 and swim toward the current 14. The structure 20 has a diameter opening, making it difficult, if not physically impossible, for a fish to turn around. The fish 100 is then pulled into the pump suction tube 16 as the current 32 then draws the fish into the pump. At this point, the fish are being sucked into the system intake and the suction tube 16 is too small for the fish to turn around. Proper sizing of the structure 20 and suction tube 16 must be considered for the size of fish to be pumped. The use of current, followed by a current transition, results in the quick delicing of the fish.

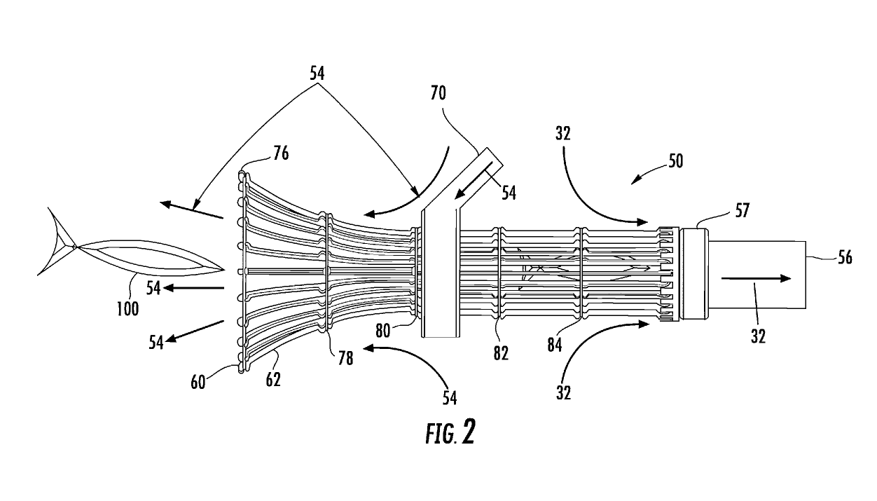

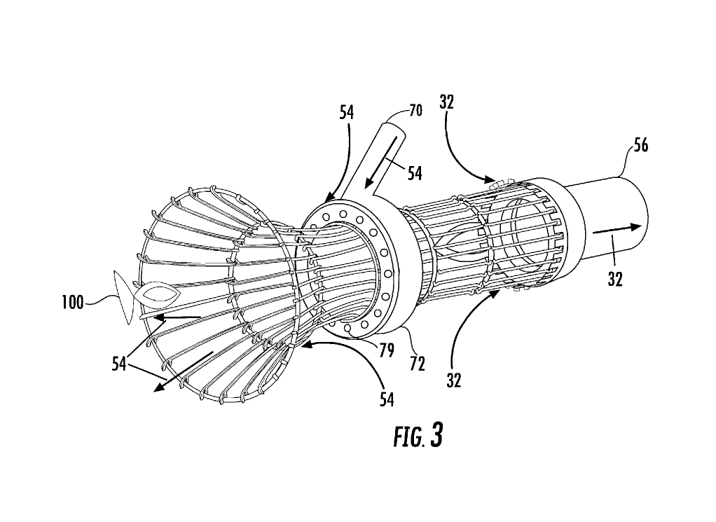

Referring to FIGS. 2 and 3, an alternative embodiment of the assembly uses a water distribution manifold 50 comprising a water pump manifold 70 with sufficient volume to create a current 54 opposite the pump suction 56 direction through a cone shaped funnel 60 positioned on the hose inlet 57 prior to the pump suction 56. In the preferred embodiment, a water pump with an output of about 0.3 to 1 foot/second is sufficient and can be provided with a 3 inch centrifugal pump with outputs of 200 to 500 GPM. The pump manifold has a circular shaped distributor 72 with a plurality of outlets 79 for creating current 54 that passes through the bars 62 that make up the funnel structure 60. Fish 100 naturally swim into this current 54 when crowded thereby entering the funnel 60 head first.

The preferred assembly is made of clear plastic bars 62 to more easily encourage the fish to enter the funnel 60 unstressed. Water flow is provided through the water manifold 70, which is designed to create a uniform balanced water flow; and, in this embodiment, the plastic bars 62 are held in position by stainless steel rings 76 along the entry to the funnel 60. The stainless steel rings 78, 80, 82 and 84 are located along the side wall of the funnel for maintaining sufficient openings for water to flow through the wall. The openings or spacing in the wall are small enough to prevent fish escape. The funnel and cone shaped tube can easily be produced from a series of closely spaced bars 62, which are less conspicuous to the entering fish, and further less visible when made of clear plastic such as acrylic or polycarbonate. The lower visibility creates less stress for the fish as it enters the funnel 60. Once the fish 100 pass the cone shaped entrance area, the fish are sucked into the system intake, which has a diameter that is too small for the fish to turn around. Proper sizing of the funnel and tube must be considered for the size of fish to be pumped. The use of current, followed by a current transition, results in the quick delicing of the fish.

The assembly includes the use of the Coanda effect pump as taught in U.S. Pat. No. 7,462,016 issued to Lindgren. The pump creates an intake suction to pump live fish without any moving parts touching the fish. As the fish move from the low pressure intake to the high pressure pump area, sea lice attached to a fish traveling head first are effectively removed by a faster current unhooking the lice.

There is an area in the Silkstream pump where the water more than doubles on the tubular surface for 1-3 inches. Salmon being deloused will be 15 to 36 inches long and traveling essentially in the center of the accelerated water stream. The faster surface water dislodges the lice attached to the scales and skin of the salmon. The process water is then separated from the fish by passing over spaced bars. The water enters into a filtration system to remove the lice prior to returning to the ocean, and the deloused fish return to cages or on to harvesting.

There is also a need to orient fish head first for harvesting. Machines that stun fish instantly to help maintain fish freshness and quality require that the fish enter head first for effective treatment. Usually, this takes several crew members to reorient tail first fish exiting the pump. The present invention would reduce the effort and cost of reorienting the fish in many harvesting operations.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. A fish delicing apparatus comprising: a funnel shaped structure having an inlet and an outlet, said structure having partially open walls formed from spaced apart bars, a water pump manifold fluidly coupled to a water pump for directing water current to exit the inlet of said funnel shaped structure, a fish pump positioned adjacent said water pump manifold for transferring fish that have passed through said water pump manifold water current;
wherein a fish will enter the inlet of said funnel shaped structure swimming against the water current and upon passing said water pump manifold the water current dissipates and is replaced by a suction caused by said fish pump, said fish pump used for delicing and transferring the fish.

2. (canceled)

3. The apparatus according to claim 1 wherein the walls are constructed of a transparent material.

4. The apparatus according to claim 1 wherein the walls extend a predetermined length from the inlet to the outlet to allow flow to the pump suction of said fish pump, wherein fish removal occurs without overcoming the water current directed from said water pump manifold.

5. The apparatus according to claim 1 wherein a diameter of the funnel shaped structure is constructed and arranged to prevent a fish that enters the funnel shaped structure from turning around before exiting the funnel shaped structure.

6. The apparatus according to claim 1 wherein the water exits the inlet of said funnel shaped structure at a current of at least 0.3 feet per second.

7. The apparatus according to claim 1 wherein said fish pump is a Coanda effect pump.

8. (canceled)
